(19) United States
(12) Patent Application Publication
(10) Pub. No.: US 2025/0322548 A1
(43) Pub. Date: Oct. 16, 2025

(54) MULTI-DIRECTIONAL 2D SNAPSHOT IMAGE TRACK FOR V3C CONTENT

(71) Applicant: Samsung Electronics Co., Ltd., Suwon-si (KR)

(72) Inventors: Youngkwon Lim, McKinney, TX (US); Rajan Laxman Joshi, San Diego, CA (US); Madhukar Budagavi, Plano, TX (US)

(21) Appl. No.: 19/176,082

(22) Filed: Apr. 10, 2025

Related U.S. Application Data
(60) Provisional application No. 63/634,034, filed on Apr. 15, 2024.

(51) Int. Cl. G06T 9/00; G06T 15/20

(52) U.S. Cl. CPC G06T 9/001; G06T 15/205

(57) ABSTRACT

An embodiment of an apparatus is directed to improvements to dynamic mesh coding for a multi-directional image track. The apparatus receives a track including one or more samples, wherein a respective one of the one or more samples includes a plurality of coded two-dimensional projected images of coded volumetric frame as a plurality of subsamples. The apparatus decodes at least one of the plurality of coded two-dimensional projected images to generate at least one of a plurality of two-dimensional projected images. The apparatus presents the at least one two-dimensional projected image.

### CROSS REFERENCE TO RELATED APPLICATION

This application claims benefit of U.S. Provisional Application No. 63/634,034, entitled “MULTI-DIMENSIONAL 2D SNAPSHOT IMAGE TRACK FOR V3C CONTENT,” filed on Apr. 15, 2024, in the United States Patent and Trademark Office, the entire contents of which are hereby incorporated by reference.

### TECHNICAL FIELD

The disclosure relates to dynamic mesh coding, and more particularly to, for example, but not limited to, multi-dimensional 2D snapshot image track for visual volumetric video-based coding (V3C) content.

### BACKGROUND

Currently, Moving Picture Experts Group (MPEG) is working on compression of volumetric contents. Both Video-based Point Cloud Compression (V3C) and Video-based Dynamic Mesh Coding (V-DMC) compresses volumetric contents such as point clouds and mesh with various technologies including conventional video compression technology. The following are such technologies: the International Organization for Standardization and the International Electrotechnical Commission (ISO/IEC) 23090-5 Video-based Point Cloud Compression, ISO/IEC 23090-29 Video-based dynamic mesh coding (V-DMC), and ISO/IEC 23090-10 Carriage of Video-based Point Cloud Compression Data.

Both V3C and V-DMC compresses volumetric contents such as point clouds and mesh with various technologies including conventional video compression technology. Compressing volumetric contents has a strong benefit for saving resources for storage and delivery of the contents. However, it introduces a challenge for quick preview or trick play of the contents similar to the challenge any other compressed video data has. As one directional or multidirectional dependent coding could have been also applied to further enhance compression efficiency, more than one video frame should be decoded to get a specific frame of volumetric content. If random access points of the components are not aligned or the frame rates of the components are different than each other, a greater number of video frames should be decoded to get the result. So, quick preview or trick play of volumetric contents which used be a straightforward easy job for uncompressed volumetric contents has become quite a complicated resource and time-consuming process when the contents are compressed.

The description set forth in the background section should not be assumed to be prior art merely because it is set forth in the background section. The background section may describe aspects or embodiments of the present disclosure.

### SUMMARY

In some embodiments, this disclosure may relate to improvements to quick preview or trick play operations of volumetric contents.

In some embodiments, a series of two-dimensional (2D) snapshot images of volumetric contents is introduced. The series of 2D snapshot images of volumetric contents may eliminate the need to decode and render volumetric contents, reducing computational costs. The 2d snapshot images for volumetric contents may be carried in a multi-directional snapshot image track.

An aspect of the disclosure provides an apparatus comprising a communication interface and a processor operably coupled to the communication interface. The communication interface is configured to receive a track. The track includes one or more samples. A respective one of the one or more samples includes a plurality of coded two-dimensional projected images of a coded volumetric frame as a plurality of sub-samples. The processor is configured to decode at least one of the plurality of coded two-dimensional projected images to generate at least one two-dimensional projected image. The processor is further configured to present the at least one two-dimensional projected image.

In some embodiments, the communication interface is further configured to receive a multi-dimensional snapshot camera information box. The multi-dimensional snapshot camera information box includes a plurality of viewport information elements. Each of the plurality of viewport information elements is associated with a respective one of the plurality of sub-samples. A respective one of the plurality of viewport information elements provides camera information for an associated sub-sample.

In some embodiments, the multi-dimensional snapshot camera information box includes number information indicating the number of sub-samples in the respective one of the one or more samples.

In some embodiments, the multi-dimensional snapshot camera information box includes a plurality of camera extrinsic flags. Each of the plurality of camera extrinsic flags is associated with a respective one of the plurality of viewport information elements and indicates whether extrinsic camera information is present in an associated viewport information element. If a respective one of the plurality of camera extrinsic flag indicates that extrinsic camera information is present in the respective one of the plurality of viewport information elements associated with the respective one of the plurality of camera extrinsic flags, the multi-dimensional snapshot camera information box further includes extrinsic camera information associated with the respective one camera extrinsic flag. The number of the plurality of camera extrinsic flags is the same as the number of the number of subsamples.

In some embodiments, the multi-dimensional snapshot camera information box includes a plurality of camera intrinsic flags. Each of the plurality of camera intrinsic flags is associated with a respective one of the plurality of viewport information elements and indicates whether intrinsic camera information is present in an associated viewport information element. If a respective one of the plurality of camera intrinsic flag indicates that intrinsic camera information is present in the respective one of the plurality of viewport information elements associated with the respective one of the plurality of camera intrinsic flags, the multi-dimensional snapshot camera information box further includes intrinsic camera information associated with the respective one camera intrinsic flag. The number of the plurality of camera intrinsic flags is the same as the number of the number of subsamples.

In some embodiments, the at least one two-dimensional projected image is presented based on the multi-dimensional snapshot camera information box.

In some embodiments, the respective one of the plurality of viewport information elements includes location information and direction information of a camera used to render a two-dimensional projected images in an associated sub-sample of the plurality of subsamples.

In some embodiments, location information and direction information of a camera for a sub-sample of the plurality of subsamples are different from location information and direction information of a camera for another sub-sample of the plurality of subsamples.

In some embodiments, the set of the location information and the direction information of cameras for the plurality of sub-samples remain the same in a single track.

An aspect of the disclosure provides an apparatus comprising a communication interface and a processor operably coupled to the communication interface. The processor is configured to encode a plurality of two-dimensional projected images of one or more volumetric frames to generate a plurality of coded two-dimensional projected images. The processor is further configured to generate a track including one or more samples. Each of the one or more samples is associated with a respective one of the one or more volumetric frames and includes at least two coded two-dimensional projected images associated with a volumetric frame as a plurality of sub-samples. The processor is further configured to transmit the track.

In some embodiments, the processor is further configured to generate a multi-dimensional snapshot camera information box. The multi-dimensional snapshot camera information box includes a plurality of viewport information elements. Each of the plurality of viewport information elements is associated with a respective one of the plurality of sub-samples. A respective one of the plurality of viewport information elements provides camera information for an associated sub-sample. The processor is further configured to transmit the multi-dimensional snapshot camera information box.

In some embodiments, the multi-dimensional snapshot camera information box includes number information indicating the number of sub-samples in the respective one of the one or more samples.

In some embodiments, the multi-dimensional snapshot camera information box includes a plurality of camera extrinsic flags. Each of the plurality of camera extrinsic flags is associated with a respective one of the plurality of viewport information elements and indicates whether extrinsic camera information is present in an associated viewport information element. If a respective one of the plurality of camera extrinsic flag indicates that extrinsic camera information is present in the respective one of the plurality of viewport information elements associated with the respective one of the plurality of camera extrinsic flags, the multi-dimensional snapshot camera information box further includes extrinsic camera information associated with the respective one camera extrinsic flag. The number of the plurality of camera extrinsic flags is the same as the number of the number of subsamples.

In some embodiments, the multi-dimensional snapshot camera information box includes a plurality of camera intrinsic flags. Each of the plurality of camera intrinsic flags is associated with a respective one of the plurality of viewport information elements and indicates whether intrinsic camera information is present in an associated viewport information element. If a respective one of the plurality of camera intrinsic flag indicates that intrinsic camera information is present in the respective one of the plurality of viewport information elements associated with the respective one of the plurality of camera intrinsic flags, the multi-dimensional snapshot camera information box further includes intrinsic camera information associated with the respective one camera intrinsic flag. The number of the plurality of camera intrinsic flags is the same as the number of the number of subsamples.

In some embodiments, the respective one of the plurality of viewport information elements includes location information and direction information of a camera used to render a two-dimensional projected images in an associated sub-sample of the plurality of subsamples.

In some embodiments, location information and direction information of a camera for a sub-sample of the plurality of subsamples are different from location information and direction information of a camera for another sub-sample of the plurality of subsamples.

In some embodiments, the set of the location information and the direction information of cameras for the plurality of sub-samples remain the same in a single track.

An aspect of the disclosure provides a method performed by an apparatus. The method comprises receiving a track. The track includes one or more samples. A respective one of the one or more samples includes a plurality of coded two-dimensional projected images of a coded volumetric frame as a plurality of sub-samples. The method further comprises decoding at least one of the plurality of coded two-dimensional projected images to generate at least one two-dimensional projected image. The method further comprises presenting the at least one two-dimensional projected image.

In some embodiments, the method further comprises receiving a multi-dimensional snapshot camera information box. The multi-dimensional snapshot camera information box includes a plurality of viewport information elements. Each of the plurality of viewport information elements is associated with a respective one of the plurality of sub-samples. A respective one of the plurality of viewport information elements provides camera information for an associated sub-sample.

In some embodiments, the multi-dimensional snapshot camera information box includes number information indicating the number of sub-samples in the respective one of the one or more samples.

### BRIEF DESCRIPTION OF THE DRAWINGS

FIG. 1 illustrates an example communication system 100 in accordance with an embodiment of this disclosure.

FIGS. 2 and 3 illustrate example electronic devices in accordance with an embodiment of this disclosure.

FIG. 4 illustrates a block diagram for an encoder encoding intra frames in accordance with an embodiment.

FIG. 5 illustrates a block diagram for a decoder in accordance with an embodiment.

FIG. 6 shows a basic block diagram of a 2D snapshot image SEI message processor in accordance with an embodiment of this disclosure.

FIG. 7 shows an example contents of a V3C bitstream in accordance with an embodiment.

FIG. 8 is a flowchart showing operations of an encoder in accordance with another embodiment.

FIG. 9 is a flowchart showing operations of a decoder in accordance with another embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

Three hundred sixty degree (360°) video and 3D volumetric video are emerging as new ways of experiencing immersive content due to the ready availability of powerful handheld devices such as smartphones. While 360° video enables immersive “real life,” “being there” experience for consumers by capturing the 360° outside-in view of the world, 3D volumetric video can provide complete 6DoF experience of being and moving within the content. Users can interactively change their viewpoint and dynamically view any part of the captured scene or object they desire. Display and navigation sensors can track head movement of the user in real-time to determine the region of the 360° video or volumetric content that the user wants to view or interact with. Multimedia data that is three-dimensional (3D) in nature, such as point clouds or 3D polygonal meshes, can be used in the immersive environment.

A point cloud is a set of 3D points along with attributes such as color, normal, reflectivity, point-size, etc. that represent an object's surface or volume. Point clouds are common in a variety of applications such as gaming, 3D maps, visualizations, medical applications, augmented reality, virtual reality, autonomous driving, multi-view replay, 6DoF immersive media, to name a few. Point clouds, if uncompressed, generally require a large amount of bandwidth for transmission. Due to the large bitrate requirement, point clouds are often compressed prior to transmission. To compress a 3D object such as a point cloud, often requires specialized hardware. To avoid specialized hardware to compress a 3D point cloud, a 3D point cloud can be transformed into traditional two-dimensional (2D) frames and that can be compressed and later be reconstructed and viewable to a user.

Polygonal 3D meshes, especially triangular meshes, are another popular format for representing 3D objects. Meshes typically can comprise a set of vertices, edges and faces that are used for representing the surface of 3D objects. Triangular meshes are simple polygonal meshes in which the faces are simple triangles covering the surface of the 3D object. Typically, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively.

Since point clouds and meshes contain a large amount of data, they require compression for efficient storage and transmission. This is particularly true for dynamic point clouds and meshes, which may contain 60 frames or higher per second.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

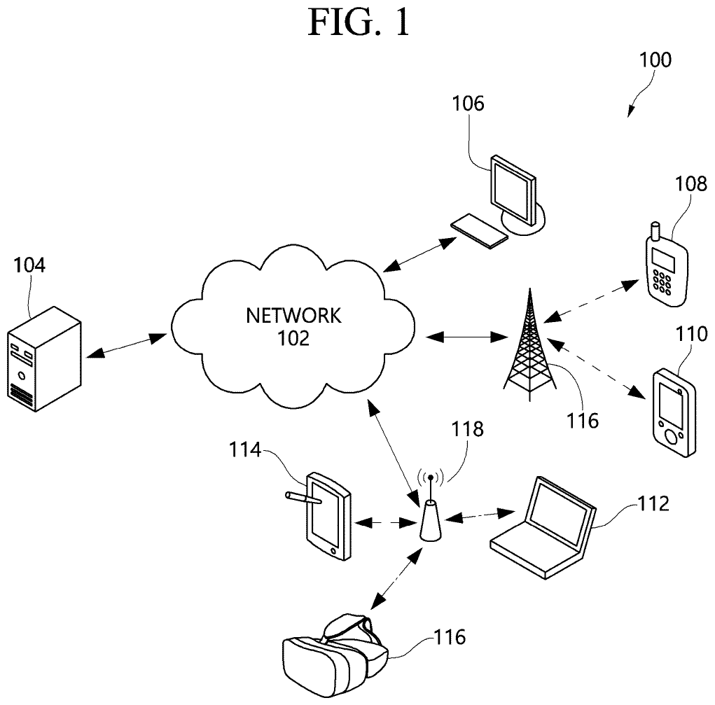

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can then compress 3D point cloud or mesh to generate a bitstream and then transmit the bitstream to one or more of the client devices 106-116. For another example, one of the client devices 106-116 can compress a 3D point cloud or mesh to generate a bitstream and then transmit the bitstream to another one of the client devices 106-116 or to the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

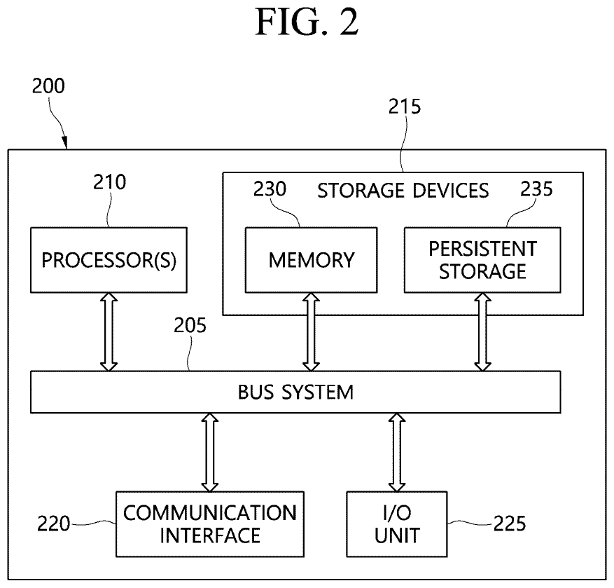

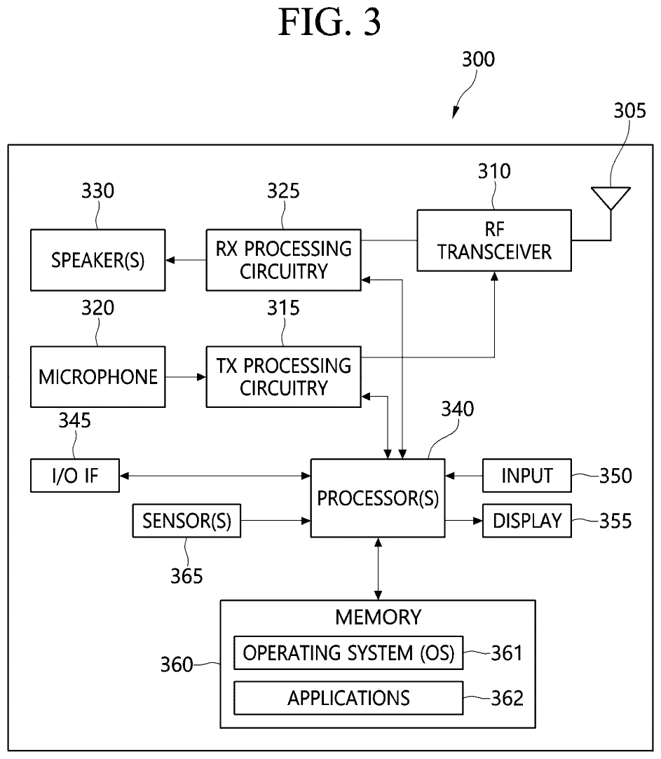

FIGS. 2 and 3 illustrate example electronic devices in accordance with an embodiment of this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

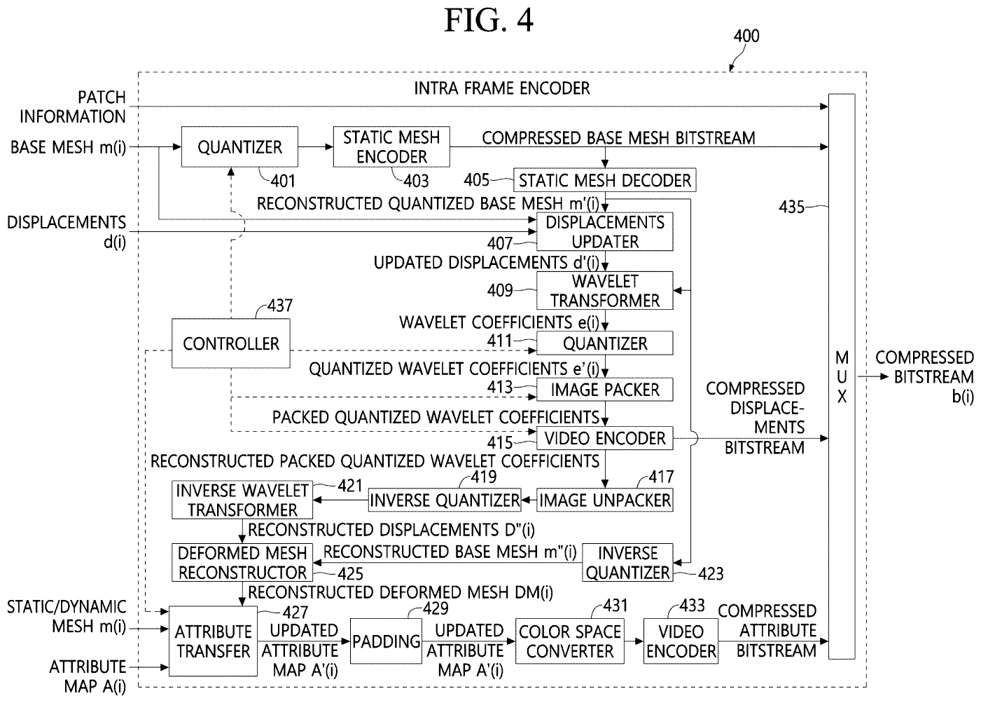

FIG. 4 illustrates a block diagram for an encoder encoding intra frames in accordance with an embodiment.

As shown in FIG. 4, the encoder 400 encoding intra frames in accordance with an embodiment may comprise a quantizer 401, a static mesh encoder 403, a static mesh decoder 405, a displacements updater 407, a wavelet transformer 409, a quantizer 411, an image packer 413, a video encoder 415, an image unpacker 417, an inverse quantizer 419, an inverse wavelet transformer 421, an inverse quantizer 423, a deformed mesh reconstructor 425, an attribute transfer module 427, a padding module 429, a color space converter 431, a video encoder 433, a multiplexer 435, and a controller 437.

The quantizer 401 may quantize a base mesh m(i) to generate a quantized base mesh. In some embodiments, the base mesh may have fewer vertices compared to an original mesh.

The static mesh encoder 403 may encode and compress the quantized base mesh to generate a compressed base mesh bitstream. In some embodiments, the base mesh may be compressed in a lossy or lossless manner. In some embodiments, an already existing mesh codec such as Draco may be used to compress the base mesh.

The static mesh decoder 405 may decode the compressed base mesh bitstream to generate a reconstructed quantized base mesh m′(i).

The displacements updater 407 may update displacements d(i) based on the base mesh m(i) after subdivision and the reconstructed quantized base mesh m′(i) to generate updated displacements d′(i). The reconstructed base mesh may undergo subdivision and then a displacement field between the original mesh and the subdivided reconstructed base mesh may be calculated. In inter coding of mesh frame, the base mesh may be coded by sending vertex motions instead of compressing the base mesh directly. In either case, a displacement field may be created. The displacement field as well as the modified attribute map may be coded using a video codec and also included as a part of the V-DMC bitstream.

The wavelet transformer 409 may perform a wavelet transform with the updated displacements d′(i) to generate displacement wavelet coefficients e(i). The wavelet transform may comprise a series of prediction and update lifting steps.

The quantizer 411 may quantize the displacement wavelet coefficients e(i) to generate quantized displacement wavelet coefficients e′(i). The quantized displacement wavelet coefficients may be denoted by an array dispQuantCoeffArray.

The image packer 413 may pack the quantized displacement wavelet coefficients e′(i) into a 2D image including packed quantized displacement wavelet coefficients dispQuantCoeffFrame. The 2D video frame may be referred to as a displacement frame or a displacement video frame in this disclosure.

The video encoder 415 may encode the packed quantized displacement wavelet coefficients dispQuantCoeffFrame to generate a compressed displacements bitstream.

The image unpacker 417 may unpack the packed quantized displacement wavelet coefficients dispQuantCoeffFrame to generate an array dispQuantCoeffArray of quantized displacement wavelet coefficients.

The inverse quantizer 419 may inversely quantize the array dispQuantCoeffArray of quantized displacement wavelet coefficients to generate displacement wavelet coefficients.

The inverse wavelet transformer 421 may perform an inverse wavelet transform with the displacement wavelet coefficients to generate reconstructed displacements d″(i).

The inverse quantizer 423 may inversely quantize the reconstructed quantized base mesh m′(i) to generate a reconstructed base mesh m″(i).

The deformed mesh reconstructor 425 may generate a reconstruct deformed mesh DM(i) based on the reconstructed displacements D″(i) and a reconstructed base mesh m″(i).

The attribute transfer module 427 may update an attribute map A(i) based on a static/dynamic mesh m(i) and a reconstructed deformed mesh DM(i) to generate an updated attribute map A′(i). The attribute map may be a texture map but other attributes may be sent as well.

The padding module 429 may perform padding to fill empty areas in the updated attribute map A′(i) so as to remove high frequency components.

The color space converter 431 may perform a color space conversion of the padded updated attribute map A′(i).

The video encoder 433 may encode the output of the color space converter 431 to generate the compressed attribute bitstream.

The multiplexer 435 may multiplex the compressed base mesh bitstream, the compressed displacements bitstream, and the compressed attribute bitstream to generate a compressed bitstream b(i).

The controller 437 may control modules of the encoder 400.

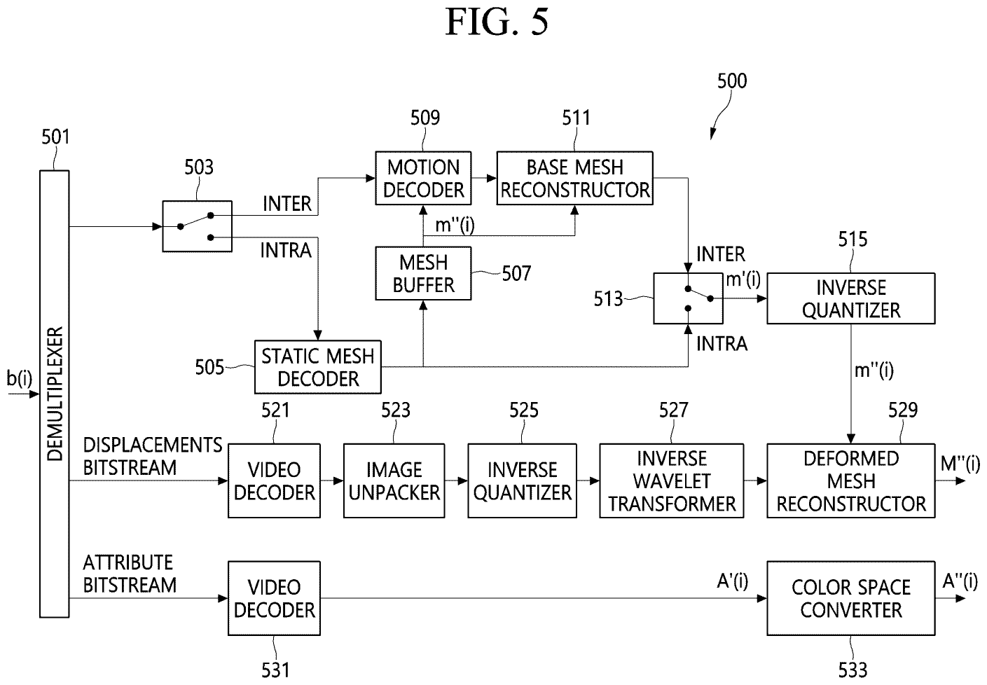

FIG. 5 illustrates a block diagram for a decoder in accordance with an embodiment.

As shown in FIG. 5, the decoder 500 may comprise a demultiplexer 501, a switch 503, a static mesh decoder 505, a mesh buffer 507, a motion decoder 509, a base mesh reconstructor 511, a switch 513, an inverse quantizer 515, a video decoder 521, an image unpacker 523, an inverse quantizer 525, an inverse wavelet transformer 527, a deformed mesh reconstructor 529, a video decoder 531, and a color space converter 533.

The demultiplexer 501 may receive the compressed bitstream b(i) from the encoder 400 to extract the compressed base mesh bitstream, the compressed displacements bitstream, and the compressed attribute bitstream from the compressed bitstream b(i).

The switch 503 may determine whether the compressed base mesh bitstream has an inter-coded mesh frame or an intra-coded mesh frame. If the compressed base mesh bitstream has the inter-coded mesh frame, the switch 503 may transfer the inter-coded mesh frame to the motion decoder 509. If the compressed base mesh bitstream has the intra-coded mesh frame, the switch 503 may transfer the intra-coded mesh frame to the static mesh decoder 505.

The static mesh decoder 505 may decode the intra-coded mesh frame to generate a reconstructed quantized base mesh frame.

The mesh buffer 507 may store the reconstructed quantized base mesh frames and the inter-coded mesh frame for future use of decoding subsequent inter-coded mesh frames. The reconstructed quantized base mesh frames may be used as reference mesh frames.

The motion decoder 509 may obtain motion vectors for a current inter-coded mesh frame based on data stored in the mesh buffer 507 and syntax elements in the bitstream for the current inter-coded mesh frame. In some embodiments, the syntax elements in the bitstream for the current inter-coded mesh frame may be a motion vector difference.

The base mesh reconstructor 511 may generate a reconstructed quantized base mesh frame by using syntax elements in the bitstream for the current inter-coded mesh frame based on the motion vectors for the current inter-coded mesh frame.

The switch 513 may transmit the reconstructed quantized base mesh frame from the static mesh decoder 505 to the inverse quantizer 515, if the compressed base mesh bitstream has the intra-coded mesh frame. The switch 513 may transmit the reconstructed quantized base mesh frame from the static mesh decoder 511 to the inverse quantizer 515, if the compressed base mesh bitstream has the inter-coded mesh frame.

The inverse quantizer 515 may perform an inverse quantization with the reconstructed quantized base mesh frame to generate a reconstructed base mesh frame m″(i).

The video decoder 521 may decode a displacements bitstream to generate packed quantized displacement wavelet coefficients dispQuantCoeffFrame.

The image unpacker 523 may unpack the packed quantized displacement wavelet coefficients dispQuantCoeffFrame to generate an array dispQuantCoeffArray of quantized displacement wavelet coefficients.

The inverse quantizer 525 may perform the inverse quantization with the array dispQuantCoeffArray of quantized displacement wavelet coefficients to generate displacement wavelet coefficients.

The inverse wavelet transformer 527 may perform the inverse wavelet transform with displacement wavelet coefficients to generate displacements.

The deformed mesh reconstructor 529 may reconstruct a deformed mesh based on the displacements and the reconstructed base mesh frame m″(i).

The video decoder 531 may decode the attribute bitstream to generate an attribute map before a color space conversion.

The color space converter 533 may perform a color space conversion of the attribute map from the video decoder 531 to reconstruct the attribute map.

The following documents are hereby incorporated by reference into the present disclosure as if fully set forth herein: i) ISO/IEC 23090-5 Video-based Point Cloud Compression; ii) ISO/IEC 23090-29 Video-based dynamic mesh coding (V-DMC); and iii) ISO/IEC 23090-10 Carriage of Video-based Point Cloud Compression Data.

A user may simplify a quick preview or trick play operation by utilization of a two-dimensional (2D) snapshot image of volumetric content. The 2D snapshot image is generated at a certain point of time with a camera at a certain position and direction. A user may decode a 2D snapshot image instead of volumetric contents. Volumetric contents may be decoded by decoding compressed bitstreams and compositing or rendering volumetric contents, but the operations to ultimately render the volumetric content are costly. A user may instead present the decoded 2D snapshot image.

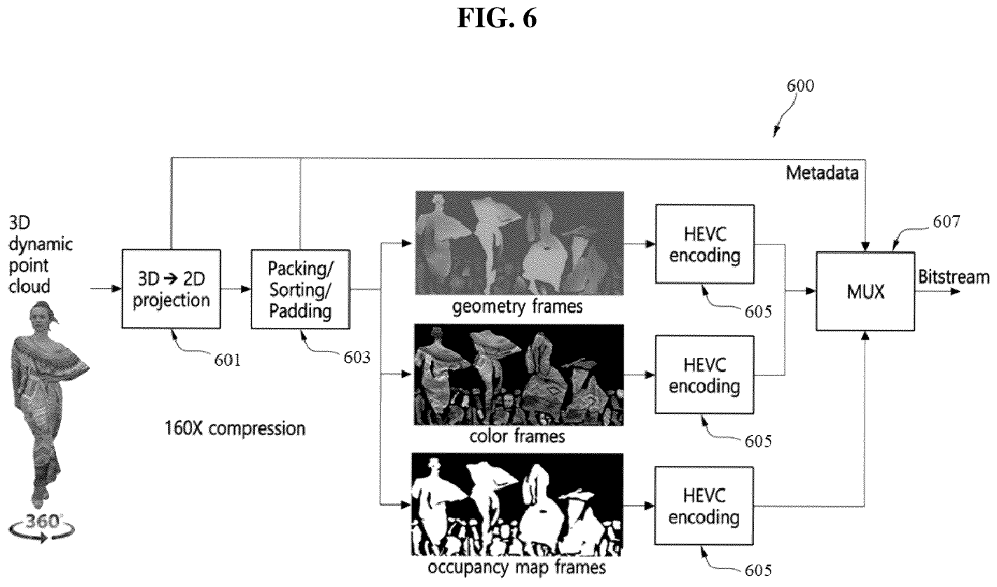

FIG. 6 shows a basic block diagram of a 2D snapshot image supplemental enhancement information (SEI) message in accordance with an embodiment of this disclosure.

Referring to FIG. 6, the 2D snapshot SEI message processor 600 in accordance with an embodiment includes a three-dimensional (3D)-to-2D image processor 601, a packing, sorting and padding processor 603, one or more high-efficiency video coding (HEVC) encoders 605 and a multiplexer 607.

The 3D-to-2D image processor 601 may present a photo generated by a camera based on the 3D position and direction vector of a viewport camera in the 3D frame to generate a 2D snapshot image and some metadata. The packing, sorting and padding processor 603 may pack, sort and pad the 2D snapshot image to generate a geometry frame, a color frame, an occupancy map frame and some metadata. The HEVC encoder(s) 605 may encode the geometry frame, the color frame and the occupancy map frame to generate a geometry sub-bitstream, a color sub-bitstream and an occupancy map sub-bitstream. The multiplexer 607 may combine the geometry sub-bitstream, the color sub-bitstream, the occupancy map sub-bitstream and the metadata to generate a compressed bitstream.

A volumetric frame can be viewed from multiple directions so a single 2D snapshot image may not provide sufficient information about the volumetric frame. More than one 2D snapshot images can be provided by adding more than one snapshot image tracks. This, however, would be quite inefficient in certain use cases, such as a camera being fixed for entire volumetric frames in a track. Modern video codecs, such as HEVC, Versatile Video Coding (VVC) or Essential Video Coding (EVC), provide mechanisms to include more than one subset of images such as tiles or subpictures. ISO/IEC 14496-15 can indicate each subset as a separate sub-sample and this feature can be used to include more than one snapshot images when the camera information is the same for all samples in a track.

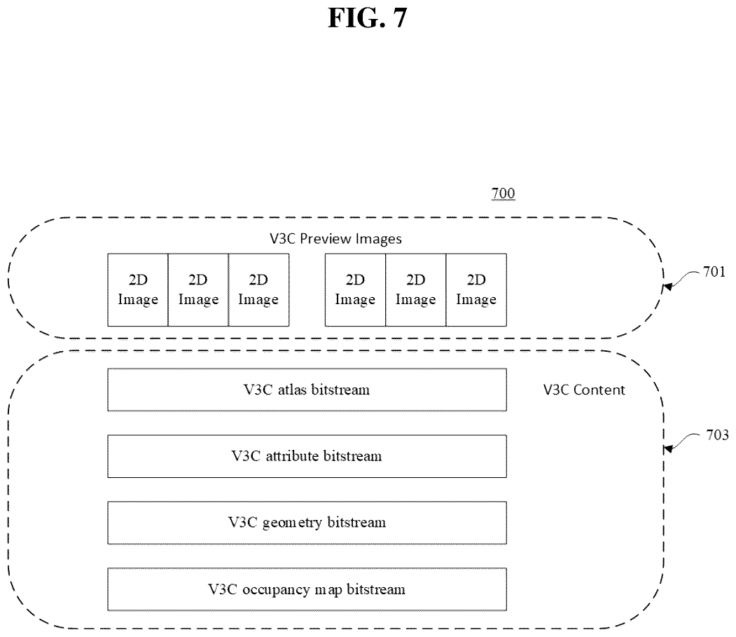

FIG. 7 shows an example contents of a V3C bitstream in accordance with an embodiment of this disclosure.

Referring to FIG. 7, a V3C bitstream 700 comprises a coded V3C preview images 701 and a coded V3C content 703. The V3C preview images 701 and V3C content 703 are coded using widely available video and image coding specifications. The V3C bitstream is formed by multiplexing the coded V3C preview images 701 and the coded V3C content 703. The V3C preview images 701 includes one or more samples of V3C content including sub-samples of 2D snapshot images. The V3C content 703 includes a V3C atlas bitstream, a V3C attribute bitstream, a V3C geometry bitstream and a V3C occupancy map bitstream.

The V3C preview images 701 can be decoded to generate the 2D snapshot images. Each sample of a volumetric frame includes a plurality of subsamples of 2D snapshot images. Each subsample of 2D snapshot image is rendered with a camera at a different position and direction at the same time.

In some embodiments, a multi-directional snapshot image track can include one or more samples of coded volumetric frames. In some embodiments, each of the one or more samples may be associated with a respective one of the one or more coded volumetric frames. Each sample comprises a plurality of sub-samples. Each sub-sample includes a 2D projected image of a coded volumetric frame associated with a sample which the sub-sample belongs to.

In some embodiments, a set of a location and a direction of projection of a sub-sample in a sample may differ from a set of a location and a direction of another sub-sample in the sample. For example, a combination of a location and a direction of a camera used to render a 2D snapshot image in a sub-sample in a sample may be different from a combination of a location and a direction of a camera used to render a 2D snapshot image in another sub-sample in the sample.

In some embodiments, the multi-directional snapshot image track includes a SubSampleInformationBox that provides sub-sample information. For example, the SubSampleInformationBox may provide information for sub-samples of the one or more samples. Such information may include a location and a direction of project of a camera used to render a 2D snapshot image in a sub-sample.

In some embodiments, the set of locations and directions of cameras used for projection may remain the same across the one or more samples in a single track. For example, a set of combinations of locations and cameras used to render 2D snapshot images for sub-samples in any sample in a single track may be the same as a set of combinations of locations and directions of cameras for sub-samples in another sample in the single track.

In some embodiments, a composition time of 2D snapshot images of a coded volumetric frame is the same as a composition time of the coded volumetric frame associated with the sample containing the 2D snapshot images.

In some embodiments, a 2D snapshot image track may be associated with tracks comprising V3C data by a track reference. The V3C data may comprise V3C video components that may be encoded as independent subpictures in one picture and then divided into tracks for each V3C video component. The tracks for each V3C video component may comprise the following subpicture tracks: the occupancy video component track, the geometry video component track and the attribute video component track. The track reference may be by the track reference tool of ISO/IEC 14496-12. One or more TrackReferenceTypeBoxes may be added to a TrackReferenceBox within the TrackBox of the V3C atlas track or V3C atlas tile track. For convenience, the V3C atlas track or V3C atlas tile track may be referred to as a volumetric atlas track. In some embodiments, the volumetric atlas track may refer to the occupancy video component track, the geometry video component track and the attribute video component track. For convenience, the occupancy video component track, the geometry video component track and the attribute video component track may be referred to as volumetric data tracks. The TrackReferenceTypeBoxes may be added to a TrackReferenceBox for a 2D snapshot image track. The TrackReferenceTypeBox may comprise an array of track_IDs. The track_IDs may designate the tracks comprising 2D snapshot images which the V3C atlas track or V3C atlas tile track references. In some embodiments, a 4CC value of reference_type of the TrackReferenceTypeBox may be required to be ‘mdsi’.

In some embodiments, a restriction to 2D snapshot image track may be as follows: the 2D snapshot image track referenced from a V3C atlas track or V3C atlas tile track with reference_type ‘mdsi’ may be represented in a file as restricted video. The 2D snapshot image track may use a generic sample entry ‘resv’ with additional requirements. The additional requirements may be that there is a variable SchemeTypeBox in RestrictedSchemeInfoBox and scheme_type is set to ‘mdst’, all samples in the track may be required to be sync samples and that there is a variable SubSampleInformationBox. A value of subsample_count of SubSampleInformationBox is the same for all entries and greater than one.

In some embodiments, a SchemeInformationBox may be used where a variable box type is set to ‘mdst’, a variable mandatory is set to ‘Yes’ when SchemeType is set to ‘mdst’ and a variable Quantity is set to ‘One’. A multi-dimensional snapshot camera information box can be used to indicate information about a camera used to render snapshots of volumetric frames for each sub-sample of a sample of more than one 2D snapshot images indicated by SubSampleInformationBox. An i-th viewport information indicates an i-th sub-sample in bitstream order within a sample.

In some embodiments, a multi-dimensional snapshot camera information box may be defined according to syntax shown in Table 1.

```
TABLE 1
aligned(8) class MultiDimSnapshotCameraInfoBox extends extends
FullBox(‘mdst’, version = 0, 0)
{
  unsigned int(8) num_viewports;
  for (int i = 1; i <= num_viewports; i++){
    unsigned int(1) camera_extrinsic_flag[i];
    unsigned int(1) camera_intrinsic_flag[i];
    bit(6) reserved = 0;
    ViewportInfo (camera_extrinsic_flag[i], camera_intrinsic_flag[i]);
  }
}
```

In Table 1, an i-th viewport information indicates an i-th subsample in bitstream order within a sample. The i-th viewport provides information about a camera used for an i-th sub-sample in bitstream order.

The variable num_viewport indicates the number of viewports signaled in the sample. The value of this field is set to a value of subsample_count of SubSampleInformationBox. For example, the number of viewports/cameras of a sample is the same as the number of sub-samples in the sample.

The variable camera_intrinsic_flag[i] is a flag that indicates whether intrinsic camera parameters are present in an i-th viewport. A value of 1 indicates that the intrinsic camera parameters are present in the i-th viewport. A value of 0 indicates that the intrinsic camera parameters are not present in the i-th viewport. The number of flags in the variable camera_intrinsic_flag[i] of a sample is the same as the number of sub-samples in the sample.

The variable camera_extrinsic_flag[i] is a flag that indicates whether extrinsic camera parameters are present in an i-th viewport. A value of 1 indicates that the extrinsic camera parameters are present in the i-th viewport. A value of 0 indicates that the extrinsic camera parameters are not present in the i-th viewport. The number of flags in the variable camera_extrinsic_flag[i] of a sample is the same as the number of sub-samples in the sample.

The variable ViewportInfo provides information about a camera used for an i-th subsample in bitstream order. The variable ViewportInfo may be defined according syntax shown in Table 2.

```
TABLE 2
aligned(8) class ViewportInfo (ext_camera_flag, int_camera_flag) {
  if (ext_camera_flag == 1){
    unsigned int(1) center_view_flag;
    bit(6) reserved = 0;
    if (center_view_flag == 0) {
      unsigned int(1) left_view_flag;
    } else {
      bit(1) reserved = 0;
    }
    ExtCameraInfo extCamInfo ( );
  }
  if (int_camera_flag == 1) {
    IntCameraInfo intCamInfo( );
  }
}
```

In Table 2, the variable center_view_flag is a flag indicating whether the signaled viewport position corresponds to the center of the viewport or to one of two stereo positions of the viewport. A value of 1 indicates that the signaled viewport position corresponds to the center of the viewport. A value of 0 indicates that the signaled viewport position corresponds to one of two stereo positions of the viewport.

The variable left_view_flag is a flag indicating whether the signaled viewport information corresponds to the left stereo position or the right stereo position of the viewport. A value of 1 indicates that the signaled viewport information corresponds to the left stereo position of the viewport. A value of 0 indicates that the viewport information signaled corresponds to the right stereo position of the viewport.

The variable extCamInfo is an instance of ExtCameraInfo defining extrinsic camera parameters for the viewport.

The variable intCamInfo is an instance of IntCameraInfo defining intrinsic camera parameters for the viewport.

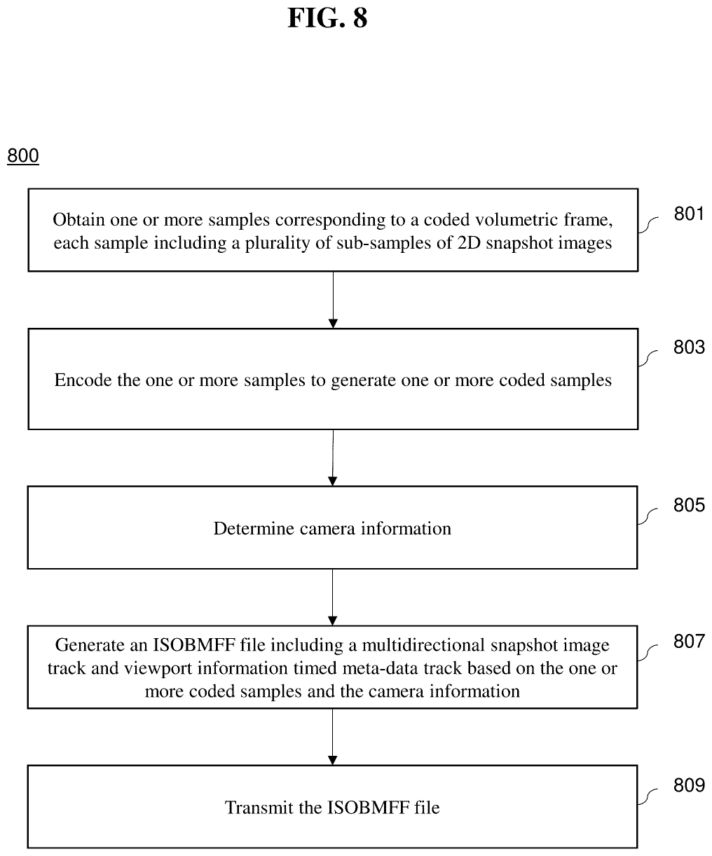

FIG. 8 is a flowchart showing operations of an encoder in accordance with another embodiment.

Referring to FIG. 8, the process 800 begins at operation 801. In operation 801, a V-DMC encoder 400 obtains one or more of more samples corresponding to a coded volumetric frame. Each of the one or more samples includes a plurality of sub-samples of 2D snapshot images. Each sub-sample is associated with a respective one of a plurality of locations and directions of a camera used for projection of the 2D snapshot image. A composition time of each sub-sample is the same as the composition time of the corresponding coded volumetric frame.

In operation 803, the V-DMC encoder 400 encodes the one or more samples corresponding to the coded volumetric frame to generate one or more coded samples.

In operation 805, the V-DMC encoder 400 determines camera information. The camera information includes the plurality of locations and directions of each camera used for projection of a 2D snapshot image of a respective one of the plurality of sub-samples. The camera information about a camera comprises a camera position for coordinates x, y and z, and a camera direction components x, y and z. The camera direction components determine a direction vector which is the direction the camera was facing.

In operation 807, the V-DMC encoder 400 generates an ISO base media file format (ISOBMFF) file including a multidirectional snapshot image track and viewport information timed meta-data track based on the one or more coded samples and the camera information. In some embodiments, the ISOBMFF file may further include an atlas track containing an array of track identifiers which designate tracks containing 2D snapshot images which the atlas track references. In some embodiments, the atlas track may be a V3C atlas track or a V3C atlas tile track. The V3C atlas track may represent the volumetric visual track containing V3C atlas bitstream in case of multi-track container. The V3C atlas tile track may represent the volumetric visual track containing portion of the V3C atlas bitstream corresponding to one or more tiles in case of a multi-track container.

In operation 809, the V-DMC encoder 400 transmits the ISOBMFF file.

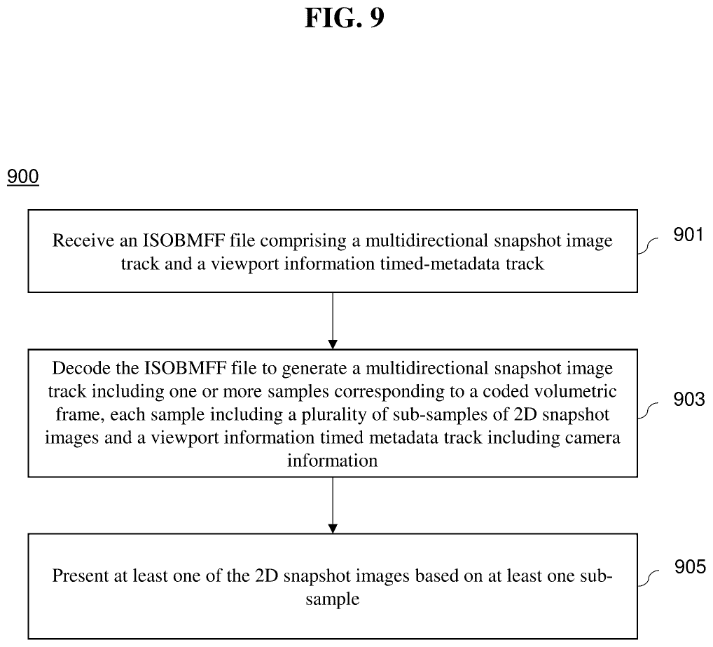

FIG. 9 is a flowchart showing operations of a decoder in accordance with another embodiment.

Referring to FIG. 9, the process 900 begins at operation 901. In operation 901, a V-DMC decoder 500 receives an ISOBMFF file comprising a multidirectional snapshot image track and a viewport information timed-metadata track. In some embodiments, the multidirectional snapshot image track comprises one or more samples corresponding to a coded volumetric frame. Each sample includes a plurality of sub-samples of 2D snapshot images. In some embodiments, the viewport information timed-metadata track may contain the camera information. The camera information include position and direction information associated with each sub-sample of a 2D snapshot image. In some embodiments, the ISOBMFF file may further include an atlas track containing an array of track identifiers which designate tracks containing 2D snapshot images which the atlas track references. In some embodiments, the atlas track may be a V3C atlas track or a V3C atlas tile track. The V3C atlas track may represent the volumetric visual track containing V3C atlas bitstream in case of multi-track container. The V3C atlas tile track may represent the volumetric visual track containing portion of V3C atlas bitstream corresponding to one or more tiles in case of multi-track container.

In operation 903, the V-DMC decoder 500 decodes the ISOBMFF file to generate a multidirectional snapshot image track including one or more samples corresponding to a coded volumetric frame, each sample including a plurality of sub-samples of 2D snapshot images, and a viewport information timed metadata track including camera information.

In operation 905, the V-DMC decoder 500 presents at least one of the 2D snapshot images based on at least one sub-sample. In some embodiments, the presenting of the at least one of the 2D snapshot images may be based on associated camera information.

The disclosure provides improvements to quick preview or trick play operations of volumetric contents by implementation of a multidirectional snapshot image track.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus comprising:
a communication interface configured to receive a track including one or more samples, wherein a respective one of the one or more samples includes a plurality of coded two-dimensional projected images of a coded volumetric frame as a plurality of sub-samples; and
a processor operably coupled to the communication interface, the processor configured to:
decode at least one of the plurality of coded two-dimensional projected images to generate at least one two-dimensional projected image, and
present the at least one two-dimensional projected image.

2. The apparatus of claim 1, wherein the communication interface is further configured to receive a multi-dimensional snapshot camera information box, wherein the multi-dimensional snapshot camera information box includes a plurality of viewport information elements,
each of the plurality of viewport information elements is associated with a respective one of the plurality of sub-samples, and
a respective one of the plurality of viewport information elements provides camera information for an associated sub-sample.

3. The apparatus of claim 2, wherein the multi-dimensional snapshot camera information box includes number information indicating the number of sub-samples in the respective one of the one or more samples.

4. The apparatus of claim 3, wherein the multi-dimensional snapshot camera information box includes a plurality of camera extrinsic flags, wherein each of the plurality of camera extrinsic flags is associated with a respective one of the plurality of viewport information elements and indicates whether extrinsic camera information is present in an associated viewport information element,
if a respective one of the plurality of camera extrinsic flag indicates that extrinsic camera information is present in the respective one of the plurality of viewport information elements associated with the respective one of the plurality of camera extrinsic flags, the multi-dimensional snapshot camera information box further includes extrinsic camera information associated with the respective one camera extrinsic flag, and
the number of the plurality of camera extrinsic flags is the same as the number of the number of subsamples.

5. The apparatus of claim 3, wherein the multi-dimensional snapshot camera information box includes a plurality of camera intrinsic flags, wherein each of the plurality of camera intrinsic flags is associated with a respective one of the plurality of viewport information elements and indicates whether intrinsic camera information is present in an associated viewport information element,
if a respective one of the plurality of camera intrinsic flag indicates that intrinsic camera information is present in the respective one of the plurality of viewport information elements associated with the respective one of the plurality of camera intrinsic flags, the multi-dimensional snapshot camera information box further includes intrinsic camera information associated with the respective one camera intrinsic flag, and
the number of the plurality of camera intrinsic flags is the same as the number of the number of subsamples.

6. The apparatus of claim 2, wherein the at least one two-dimensional projected image is presented based on the multi-dimensional snapshot camera information box.

7. The apparatus of claim 2, wherein the respective one of the plurality of viewport information elements includes location information and direction information of a camera used to render a two-dimensional projected images in an associated sub-sample of the plurality of subsamples.

8. The apparatus of claim 7, wherein location information and direction information of a camera for a sub-sample of the plurality of subsamples are different from location information and direction information of a camera for another sub-sample of the plurality of subsamples.

9. The apparatus of claim 7, wherein the set of the location information and the direction information of cameras for the plurality of sub-samples remain the same in a single track.

10. An apparatus comprising:
a communication interface; and
a processor operably coupled to the communication interface; the processor configured to:
encode a plurality of two-dimensional projected images of one or more volumetric frames to generate a plurality of coded two-dimensional projected images;
generate a track including one or more samples, wherein each of the one or more samples is associated with a respective one of the one or more volumetric frames and includes at least two coded two-dimensional projected images associated with a volumetric frame as a plurality of sub-samples; and
transmit the track.

11. The apparatus of claim 10, wherein the processor is further configured to:
generate a multi-dimensional snapshot camera information box, wherein the multi-dimensional snapshot camera information box includes a plurality of viewport information elements, each of the plurality of viewport information elements is associated with a respective one of the plurality of sub-samples, and a respective one of the plurality of viewport information elements provides camera information for an associated sub-sample; and
transmit the multi-dimensional snapshot camera information box.

12. The apparatus of claim 11, wherein the multi-dimensional snapshot camera information box includes number information indicating the number of sub-samples in the respective one of the one or more samples.

13. The apparatus of claim 12, wherein the multi-dimensional snapshot camera information box includes a plurality of camera extrinsic flags, wherein each of the plurality of camera extrinsic flags is associated with a respective one of the plurality of viewport information elements and indicates whether extrinsic camera information is present in an associated viewport information element,
if a respective one of the plurality of camera extrinsic flag indicates that extrinsic camera information is present in the respective one of the plurality of viewport information elements associated with the respective one of the plurality of camera extrinsic flags, the multi-dimensional snapshot camera information box further includes extrinsic camera information associated with the respective one camera extrinsic flag, and
the number of the plurality of camera extrinsic flags is the same as the number of the number of subsamples.

14. The apparatus of claim 12, wherein the multi-dimensional snapshot camera information box includes a plurality of camera intrinsic flags, wherein each of the plurality of camera intrinsic flags is associated with a respective one of the plurality of viewport information elements and indicates whether intrinsic camera information is present in an associated viewport information element,
if a respective one of the plurality of camera intrinsic flag indicates that intrinsic camera information is present in the respective one of the plurality of viewport information elements associated with the respective one of the plurality of camera intrinsic flags, the multi-dimensional snapshot camera information box further includes intrinsic camera information associated with the respective one camera intrinsic flag, and
the number of the plurality of camera intrinsic flags is the same as the number of the number of subsamples.

15. The apparatus of claim 10, wherein the respective one of the plurality of viewport information elements includes location information and direction information of a camera used to render a two-dimensional projected images in an associated sub-sample of the plurality of subsamples.

16. The apparatus of claim 15, wherein location information and direction information of a camera for a sub-sample of the plurality of subsamples are different from location information and direction information of a camera for another sub-sample of the plurality of subsamples.

17. The apparatus of claim 15, wherein the set of the location information and the direction information of cameras for the plurality of sub-samples remain the same in a single track.

18. A method performed by an apparatus comprising:
receiving a track including one or more samples, wherein a respective one of the one or more samples includes a plurality of coded two-dimensional projected images of a coded volumetric frame as a plurality of sub-samples;
decoding at least one of the plurality of coded two-dimensional projected images to generate at least one two-dimensional projected image; and
presenting the at least one two-dimensional projected image.

19. The method of claim 18, wherein the method further comprises:
receiving a multi-dimensional snapshot camera information box, wherein the multi-dimensional snapshot camera information box includes a plurality of viewport information elements,
wherein each of the plurality of viewport information elements is associated with a respective one of the plurality of sub-samples, and
a respective one of the plurality of viewport information elements provides camera information for an associated sub-sample.

20. The method of claim 19, wherein the multi-dimensional snapshot camera information box includes number information indicating the number of sub-samples in the respective one of the one or more samples.
